(19) United States
(12) Patent Application Publication
(10) Pub. No.: US 2005/0133071 A1
(43) Pub. Date: Jun. 23, 2005

(54) Home car washing apparatus

(76) Inventor: Scott Brady, Henderson, NV (US)

Correspondence Address: MICHAEL A. SHIPPEY, PH. D., 4848 LAKEVIEW AVENUE, SUITE B, YORBA LINDA, CA, 92886, US

(21) Appl. No.: 10/742,135

(22) Filed: Dec. 19, 2003

(51) Int. Cl. B08B 3/02

(52) U.S. Cl. 134/56 R; 134/58 R; 134/123; 134/172; 134/113; 134/94.1; 134/100.1

(57) ABSTRACT

The invention herein described is an apparatus designed for the washing of cars in a casual environment, such as outside a residential home, by a homeowner or other untrained user. The device is easily transportable, for instance from a garage into the driveway or street, and is easily stowed. It is also self-propelled, and remotely controlled.

### SUMMARY DESCRIPTION OF THE INVENTION

The invention herein described is an apparatus designed for the washing of cars in a casual environment, such as outside a residential home, by a homeowner or other casual user. The device is easily transportable, for instance from a garage into the driveway or street, and is easily stowed. It is also self-propelled, and remotely controlled.

### DESCRIPTION OF THE PRIOR ART

A patent issued to Retter (U.S. Pat. No. 6,237,614) is relevant prior art. It teaches a powered retractable vehicle wash system, with said system stored overhead in a garage or drive through. It appears to be directed to commercial carwash installations.

LaHue (U.S. Pat. No. 4,936,330) teaches a portable overhead car washer that is reminiscent of a swing set for children. Chandler (U.S. Pat. No. 4,889,147) is an example of a portable car washer shaped like a U, with ramps for drive-over. The Colicchio patent (U.S. Pat. No. 6,464,063) demonstrates a car wash with water recycling capability.

Yet further prior art is found in U.S. Pat. No. 5,098,023 to Burke, in which the invention is a commercial carwash. It talks about throughput; it describes literally dozens of lines, tanks, controllers, and other components. Additionally, the Burke patent specifically claims remote controlled operation via hand-held remote control units by a driver within the car. Remote control operation is contemplated by the current invention, but in a different manner, to meter both the soap and water content of the washing fluid, and the motion of the carwash unit.

### BRIEF DESCRIPTION OF THE DRAWINGS

FIG. 1 shows a perspective view, from above, of a preferred embodiment of the present invention alongside an automobile. The automobile itself is not part of the current invention.

FIG. 2 displays an automobile passing underneath and through a preferred embodiment of the present invention, as during a washing operation, in a perspective view from above.

FIG. 3 shows a preferred embodiment of the present invention from a cutaway side view.

FIG. 4 shows an automobile passing underneath and through an alternate embodiment of the present invention as in FIG. 2, this time viewed from behind the vehicle.

FIG. 5 shows an automobile passing underneath and through an alternate embodiment of the present invention as in FIG. 2, this time viewed from in front of the vehicle.

FIG. 6 shows a preferred embodiment of the present invention, extended, from a side view.

FIG. 7 shows a preferred embodiment of the present invention, from an end view, when folded for storage.

FIG. 8 shows a preferred embodiment of the present invention, extended, from an elevated perspective view.

### OBJECTS OF THE INVENTION

An object of the present invention is to provide a washing system for a vehicle that can be used at a residential location or the like.

Another object of the present invention is to provide a portable washing system for a vehicle that can be easily stored in a home garage or the like.

Still another object of the present invention is to provide a car washing system on wheels that the user can easily move by hand, so that the washing apparatus can be rolled from the front of a vehicle to the rear of the vehicle.

Yet another object of the present invention is to provide an embodiment of the invention that allows the user to sit in his or her vehicle and drive forward and backward through the stationary washing apparatus.

A further object of the present invention is to provide an embodiment of the invention that allows the user to direct the movement of the washing apparatus so that the apparatus can, under its own power, roll forward and backward to clean a stationary vehicle.

A further object of the present invention is to provide a car washing system that can accommodate an existing a power washing apparatus.

A further object of the present invention is to provide an alternate embodiment of the invention where the power washer is incorporated into the embodiment of the invention.

A further object of the present invention is to provide a car washing system that can be assembled and disassembled to allow it to be packed and stored in a relatively small space for shipping and storage.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

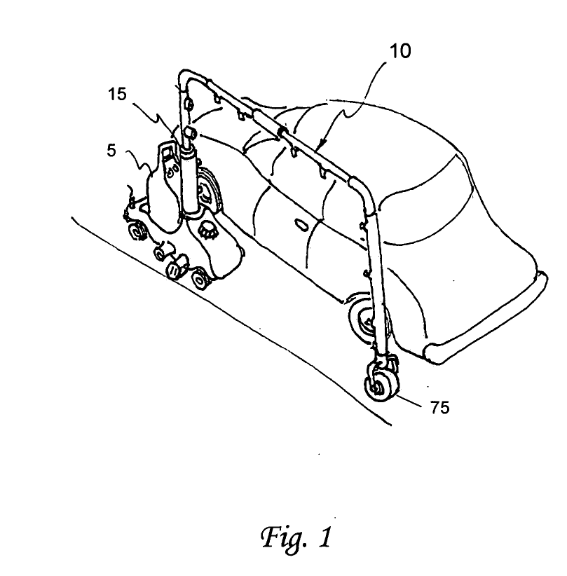

Referring to FIG. 1, we see the invention in its stored position so that it can easily fit in a standard garage of a home or the like. The swivel joint allows the inverted U-shaped tubing that transmits water and soap to a plurality of nozzles, to swing 90 degrees so that the unit can be stored along the wall of the garage.

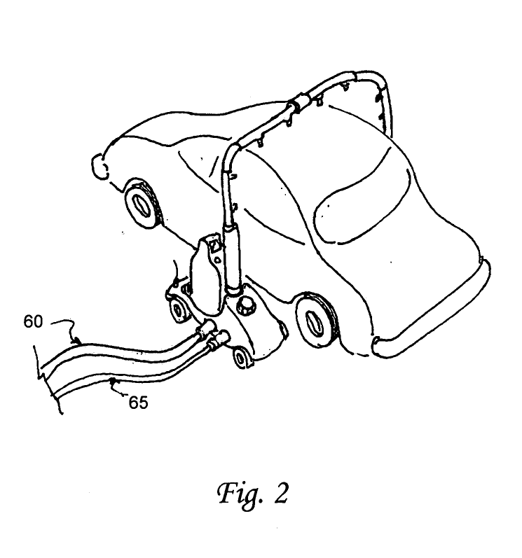

FIG. 2 shows a view of the invention in use. The inverted U-shaped pipe surrounds the side panels, tires and top of the vehicle. The U-shaped pipe and fittings are constructed of ¾ inch schedule 40-carbon steel or other suitable material that can withstand 1600 p.s.i. The nozzles are pointed inward toward the vehicle so that the water and or soap contained within the U-shaped pipe can evenly wash the vehicle. A garden type water hose is connected to the invention as well as an electrical cable capable of delivering 120 V AC.

The invention includes its own wheels so that the user can roll it while washing the vehicle, or the invention can remain stationary and the user can drive his or her vehicle under the inverted U-shaped pipe. Alternately, a small drive motor can be installed within the housing of the invention so that the user can direct the wheeled invention to travel forward and backward to wash the vehicle, This can be done by a remote control transmitter held by the user, and can be done while sitting in the vehicle or standing outside the vehicle. This configuration insures the correct transit speed so that ideal washing can occur.

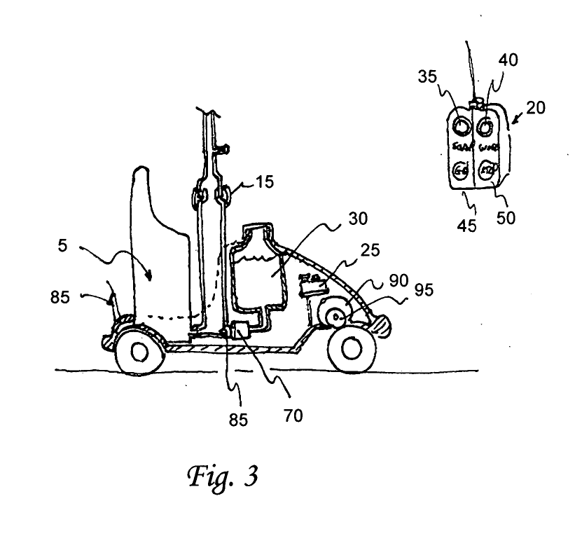

FIG. 3 shows a side section view of the invention. A power washer 5—such as a Husky 1650 (available in many hardware stores) is inserted into the space allocated for it. Alternately, a power-washing device can be built into the housing of the invention. The power washer puts out a water pressure of approximately 1300 p.s.i, and delivers approximately 1.5 gallons per minute. A soap storage container 30 is also located within the housing.

During the soap-cleaning mode, a small DC pump 70 will inject the necessary amount of soap into the pressurized water. The pump can be a metering type or a peristaltic type, both of which ensure the precise control of fluid flow. A check valve 55 allows soap to enter the main U pipe 10 and restricts pressurized water from flowing back to the soap reservoir 30.

A wireless transmitter 20 is used to communicate with the carwash device via transmission to receiver 25. The transmission is enhanced by the use of antenna 85. Buttons are pressed on wireless transmitter 20 to control soap dispensing (button 35), water flow (button 40), starting the carwash in motion (button 45), and stopping the motion of the carwash (button 50). The motion buttons operate drive motor 90 to propel the carwash unit.

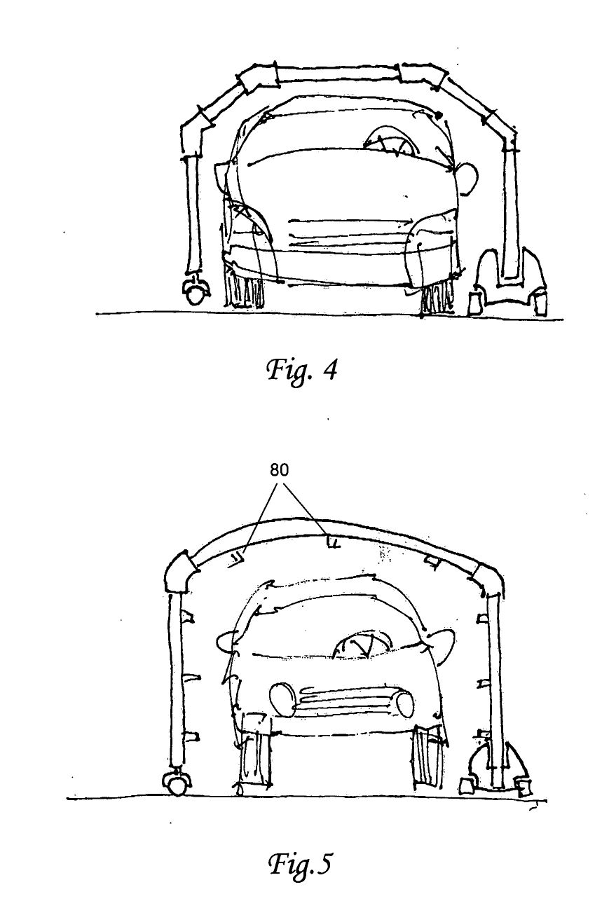

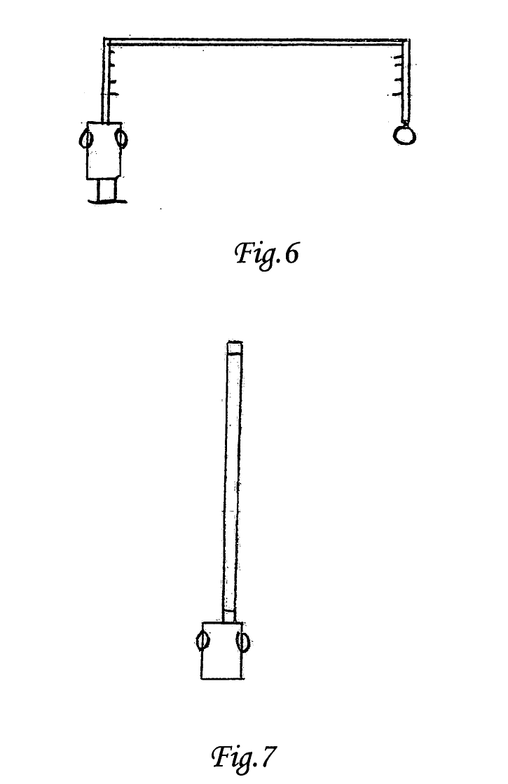

FIG. 4 shows an alternate embodiment of the invention wherein the U-shaped pipe is replaced by a more curved variant. The same is shown in FIG. 5, this time with spray heads 80 deployed.

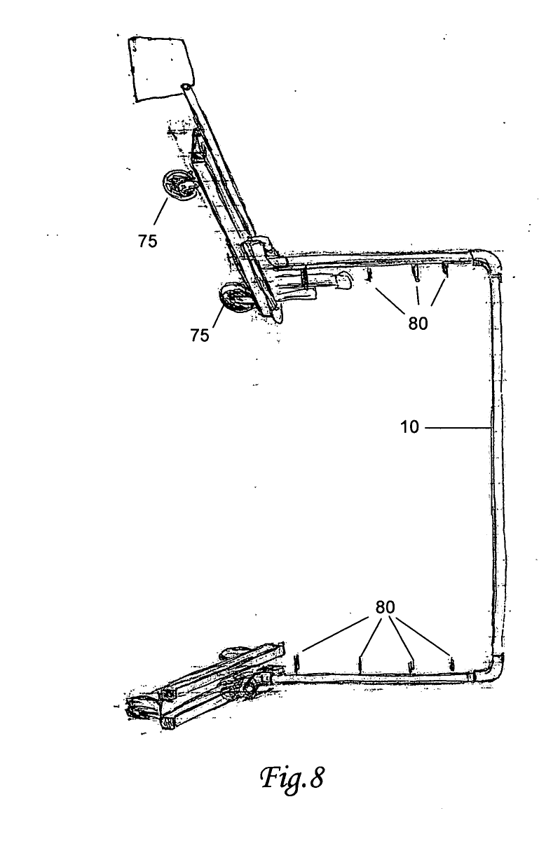

FIG. 8 shows the most detailed view of the preferred embodiment of the invention. The invention is shown ready to wash a car. Contrast to the view in FIG. 7, from an end, after the unit has been folded up for storage or transport.

### OPERATION OF THE INVENTION

During assembly the user attaches tubing members together. The central pipe comes in several lengths so that the user can customize the width of the U shape to fit his or her vehicle. He or she then installs a standard power washer into the well provided. The user attaches a water connection from the invention to the standard fitting located on the power washer. The user plugs the power cord of the power washer into a receptacle located in the well of the invention. Then the user plugs a power cord from a 110 V AC outlet located at or near the outside of the home—to the receptacle located on the outside of the unit housing. The user then attaches a standard garden hose from the home to the receptacle located on the outside of the unit housing.

The user rolls the unit out from his or her garage and onto the driveway area. The U-shaped member is swung 90 degrees, to a position perpendicular to the main body of the unit. The user then has the option to:
1. Hold the vertical part of the invention, turn the unit on, and walk it forward and backward so the U-shaped pipe travels over the vehicle (An optional switch configuration would deliver: water only, when the vehicle moves forward; water and soap, when the vehicle moves backward;—water only, when the vehicle moves forward again relative to the U-shaped pipe.)
2. Leave the invention in a stationary position and drive the vehicle forward and backward so that the vehicle is cleaned as described above
3. Use a remote transmitter to instruct a small DC drive motor assembly to automatically roll the invention forward and backward. This can be done while the user is inside or outside the vehicle.

The user also has the option to plug in a standard flexible wand so that the power washer can be used as a common power washer. Used in this manner, the user can reach and wash hard-to-clean spots on the vehicle, such as tar build up near the wheel wells.

When the user is finished, he or she rolls the invention back into the garage and swings the U-shaped pipe so that it is parallel with the sidewall of the garage. This results in a space-saving configuration of the present invention.

In one important alternate embodiment of the current invention, valves are incorporated at each spray head. This arrangement allows selected spray heads to be turned on and off. Thus, for example, the power wash unit can be directed to wash the lower body and wheel wells only of the subject vehicle.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

1. A car washing apparatus, comprising:
a chassis with a plurality of wheels, which chassis supports:
a soap reservoir tank;
means for receiving water at high pressure;
means for introducing controlled amounts of soap from said tank into the water; and
a connection to an overhead pipe, which extends to form an arc under which a vehicle may pass, said pipe containing a plurality of openings for dispensing washing liquid upon said vehicle.

2. The car washing apparatus of claim 1, wherein said openings in said pipe are spray heads.

3. The car washing apparatus of claim 1, wherein said pipe terminates at the end opposite said chassis in a small platform with a plurality of wheels for support.

4. The car washing apparatus of claim 1, wherein said connection to said overhead pipe comprises a swivel joint, allowing said overhead pipe to swivel over an arc of at least 90 degrees.

5. The car washing apparatus of claim 1, further comprising means for receiving electrical power.

6. The car washing apparatus of claim 5, wherein said means for receiving electrical power comprise an electrical connection to a 110 volt AC power line.

7. The car washing apparatus of claim 1, wherein said overhead pipe is formed in the shape of an inverted U.

8. The car washing apparatus of claim 1, wherein said apparatus is capable of containing and spraying water of at least approximately 1300 psi.

9. The car washing apparatus of claim 1, wherein said means for transferring controlled amounts of soap from said soap reservoir tank comprise a pump.

10. The car washing apparatus of claim 1, further comprising a motor, for driving said wheels for propulsion of said apparatus.

11. The car washing apparatus of claim 10, wherein said motor can propel said apparatus in either forward or backward motion.

12. The car washing apparatus of claim 1, further comprising:
a. a wireless transmitter control device;
b. an antenna; and,
c. a connected signal receiver;
d. said antenna and said signal receiver being mounted on the chassis, and said wireless transmitter control device being located remotely to said chassis.

13. The car washing apparatus of claim 12, wherein said wireless transmitter control device sends signals capable of controlling the soap dispensing rate of said apparatus.

14. The car washing apparatus of claim 12, wherein said wireless transmitter control device sends signals capable of controlling the motor of said apparatus.

15. The car washing apparatus of claim 12, wherein said wireless transmitter control device sends signals capable of controlling the motion and propulsion of said apparatus.

16. The car washing apparatus of claim 12, wherein said wireless transmitter control device sends signals capable of controlling the water flow rate of said apparatus.

17. The car washing apparatus of claim 12, wherein said antenna is capable of receiving and amplifying control signals from said wireless transmitter.

18. A car washing apparatus, comprising:
a chassis with a plurality of wheels, which chassis supports:
a soap reservoir tank;
an antenna and signal receiver;
means for receiving electrical power;
means for receiving water at high pressure;
means for introducing controlled amounts of soap from said tank into the water;
a motor, for driving said wheels for propulsion, and capable of propelling said apparatus in either forward or backward motion,
a connection to an overhead pipe, which extends to form an arc under which a vehicle may pass, said pipe containing a plurality of openings for dispensing washing liquid upon said vehicle; and,
a remotely located wireless transmitter control device capable of sending signals capable of controlling the motor, the soap dispensing rate, and the water flow rate of said apparatus.

19. The use of the car washing apparatus of claim 1 to wash a vehicle.

20. The use of the car washing apparatus of claim 18 to wash a vehicle.
